(19) United States
(12) Patent Application Publication
(10) Pub. No.: US 2026/0200677 A1
(43) Pub. Date: Jul. 16, 2026

(54) ON-BOARD ANALYSIS FOR CONDITION-BASED MONITORING OF AUTOMATIC VEHICLES OF AN AUTOMATED STORAGE SYSTEM

(71) Applicant: AutoStore Technology AS, Nedre Vats (NO)

(72) Inventors: Asheesh Saraswat, Heggedal (NO); Jørgen Djuve Heggebø, Langhus (NO)

(21) Appl. No.: 19/138,483

(22) PCT Filed: Dec. 13, 2023
(86) PCT No.: PCT/EP2023/085686

§ 371 Date: Jun. 12, 2025

(30) Foreign Application Priority Data
Dec. 16, 2022 (NO) 20221353

(51) Int. Cl. B65G 1/137; B65G 1/04; B65G 43/00; G06Q 10/20

(52) U.S. Cl. CPC B65G 1/137; B65G 1/0464; B65G 43/00; G06Q 10/20

(57) ABSTRACT

A system, method and computer program product for automated prediction and handling of condition-based need for maintenance of an automated storage and retrieval system (10) comprising a framework structure (100) having upright members (102) defining storage columns (105) for storing rows of stacked storage containers (106), the framework structure (100) comprises a rail system (108) enabling a plurality of automated vehicles (150) to handle storage containers (106) to and from the automated storage and retrieval system (10), wherein the automated storage and retrieval system (10) is controlled by a system controller (205), each automated vehicle (150) comprises a computing device (200) connected to sensors (210) arranged to monitor components and parts enabling autonomous operations. The computing device (200) is connected to a storage device (220), and arranged to continuously receive, store, process and analyse sensor data from the sensors (210), where the sensor data comprise identifications of corresponding monitored components and parts, and where sensor data showing discrepancies from reference sensor data are identified, a transmitter (230) connected to the computing device (200) is arranged to transmit, to the system controller (205), data showing discrepancies above a pre-set level from the reference data, and where the system controller (205) is adapted to process and analyse the data, and initiate maintenance of the identified components and/or parts.

### FIELD OF THE INVENTION

The present invention relates to an automated storage and retrieval system for storage and retrieval of storage containers, and to a system and method for early detection and handling of irregularities of automated vehicles of the automated storage and retrieval system.

### BACKGROUND AND PRIOR ART

FIG. 1 discloses a prior art automated storage and retrieval system 10 comprising a framework structure 100 and automated vehicles 150 handling storage containers 106 on such a system.

The framework structure 100 comprises upright members 102 and a storage volume comprising storage columns 105 arranged in rows between the upright members 102. In these storage columns 105, storage containers 106 also known as bins, are stacked one on top of one another to form stacks 107 running in the Z-direction as shown in the figure. The upright members 102 may typically be made of metal, e.g. extruded aluminium profiles.

The framework structure 100 of the automated storage and retrieval system 10 comprises a rail system 108 that is arranged across the top of the framework structure 100. The rail system 108 may also be arranged below the framework structure 100. The automated vehicles 150 are then able to handle storage container in storage columns 105 from different levels in the Z-direction where the rail system 108 is installed.

A plurality of automated vehicles 150 can be operated to raise or lower containers 106 into the storage columns 105, and to transport the storage containers 106 above and below the storage columns 105. The rail system 108 comprises a first set of parallel rails 110 arranged to guide movement of the automated vehicles 150 in a first direction X across the top of the frame structure 100, and a second set of parallel rails 111 arranged perpendicular to the first set of rails 110 to guide movement of the automated vehicles 150 in a second direction Y, which is perpendicular to the first direction X. Where rails running in the X-direction meet rails running in the Y-direction there will be rails crossings, where the automated vehicles 150 can change direction.

Storage containers 106 stored in the columns 105 are accessed by the automated vehicles 150 through access openings 112 in the rail system 108.

Each automated vehicle 150 comprises a vehicle body and first and second sets of wheels which enable the lateral movement of the container handling vehicles 150 in the X direction and in the Y direction, respectively. The vehicle body further comprises a plurality of mechanical components and electronic parts, such as transmitter, receiver, sensors, and power supply enabling autonomous operation.

For monitoring and controlling the automated storage and retrieval system 10, the system comprises a system controller 205 with a database keeping track of the location of each storage container 106 as well as which storage container 106 to be handled at any time. The system controller 205 will thus at all time have an updated overview of positions and movements of all automated vehicles 150 operating on the rail system 108. This is used for controlling traffic flow of all the automated vehicles 150 by transmitting movement instructions from the system controller 205 to the automated vehicles 150 for transporting specific storage containers 106 from one location to another location without colliding.

In addition to movement information, communication between the system controller 205 and the automated vehicles 150 also comprises status information transmitted from the automated vehicles 150 to the system controller 205. The status information may comprise current position and battery level as well as relevant data generated by sensors comprised in the automated vehicles 150.

Since an automated vehicles 150 and its components are exposed to wear and faults, it is important to detect this as soon as possible to ensure smooth and uninterrupted operation of the automated storage and retrieval system 10.

Malfunctioning components and parts are the main cause for system downtime within an automated storage and retrieval system 10, or in best case just a degradation of the system performance. Prediction of the state of different components and parts and early detection of abnormalities are key elements for improving system reliability. This is especially important when the system grows larger in size and one malfunctional component could bring down or at least reduce the efficiency of an automated storage and retrieval system 10.

All mechanical systems, and especially moving parts, are exposed to wear and tear. Several factors influence this exposure, e.g. temperature, humidity, dust, load, seasonality etc. This makes it hard to establish a common maintenance regime that is optimized for each individual site where an automated storage and retrieval system 10 is installed. In addition, there are individual differences between the automated vehicles 150 within a site, which could be hard to identify.

WO 2021/198093A1 by AutoStore proposes a system to mitigate some of these problems by keeping track of the state of different components or parts of container handling vehicles and the storage system. By placing sensors on components or parts or in connection to them, signs of wear and tear or malfunctioning can be detected. Data from the sensors are transmitted to a system controller that can decide what to do after continuously analysing all the data to assess the condition of components and parts and possibly concluding that some data reflect a problem.

Examples of sensors that can be used for detecting irregularities are temperature sensors measuring the temperature of components and parts to check if there are unusual generation of heat. Further, an accelerometer attached to a part or to the vehicle can be used to check if there is any unusual movements. An unusual movement can for instance be vibration. Vibrations also generate sounds which can be detected by a sound sensor such as a microphone. Further, energy consumption of a component or part can be monitored. This may for instance be energy consumption of the lifting system, during lifting and lowering of storage containers, e.g. a jammed storage container will result in increased friction and increased energy consumption. A higher energy consumption than normal may indicate that something is wrong with a component or part.

Remote sensors surveying the operation of container handling vehicles from a distance may also be included to detect irregularities in the operation. For instance, a microphone can also be used as a sensor for capturing sound emitted from components or parts. Also, the speed a part is operating with can be measured by a sensor.

A large automated storage and retrieval system will typically comprise many different types of sensors detecting different parameters. These will all produce large amounts of data signals that are transmitted to a system controller where the data are collected, prepared, and analysed. Continuous transmission of these signals in addition to transmission of control signals for operating the container handling vehicles will result in massive signal transmission to and from a system controller controlling the operation of the automated storage and retrieval system.

A continuous transmission of large amounts of additional data signals produced by sensors may be a problem, in view of available bandwidth, causing possible delays in transferring of signals, noise, and disturbances.

The solution to this problem, which is presented herein, is to only transmit data needing immediate attention. On-board analysis is performed by automated vehicles comprising container handling vehicles, and only data associated with components or parts needing immediate attention are transmitted to a system controller for further follow-up.

In addition to reducing bandwidth use, the solution will also reduce response time for immediately addressing serious problems in identified components or parts impairing operation, and which should be replaced or maintained.

### SUMMARY OF THE INVENTION

The present invention is set forth and characterized in the independent claims, while the dependent claims describe other characteristics of the invention.

More specifically, the invention is defined by a system for automated prediction and handling of condition-based need for maintenance of an automated storage and retrieval system comprising a framework structure having upright members defining storage columns for storing rows of stacked storage containers, the framework structure comprises a rail system enabling a plurality of automated vehicles to handle storage containers to and from the automated storage and retrieval system, wherein the automated storage and retrieval system is controlled by a system controller, each automated vehicle comprises a computing device connected to sensors arranged to monitor components and parts enabling autonomous operations.

The computing device in each an automated vehicle is connected to a storage device, and arranged to continuously receive, store, process and analyse sensor data from the sensors, where the sensor data comprise identifications of corresponding monitored components and parts, and where sensor data showing discrepancies from reference sensor data are identified,

A transmitter in each an automated vehicle is connected to the computing device that is arranged to transmit, to the system controller, data showing discrepancies above a pre-set level from the reference data, and where the system controller is adapted to process and analyse the data, and initiate maintenance of the identified components and/or parts.

According to one embodiment, the reference sensor data are previously stored data. This can be expected, or recorded sensor data generated from sensors during operations without any problems.

According to another embodiment, the reference sensor data are data generated from the sensors in each an automated vehicle during normal operations. This means that sensor data are continuously generated during different problem-free operations of handling storage containers. This will produce data sets for components and parts that are surveyed by sensors during operations. Such data will then represent the reference data.

Different types of sensors can be arranged for monitoring components and parts of an automated vehicle. According to one embodiment, the sensors monitoring components and parts of the automated vehicle comprise one or more of temperature sensor, sound sensor, humidity sensor, vibration sensor, and speed sensor.

The invention further comprises a method for automated prediction and handling of condition-based need for maintenance of an automated storage and retrieval system comprising a framework structure having upright members defining storage columns for storing rows of stacked storage containers. The framework structure comprises a rail system enabling a plurality of automated vehicles to handle storage containers to and from the automated storage and retrieval system, wherein the automated storage and retrieval system is controlled by a system controller, each automated vehicle comprises a computing device connected to a storage device and to sensors arranged to monitor components and parts enabling autonomous operations.

The method comprises the following steps:
continuously receiving, storing, processing and analysing sensor data from the sensors, including identifications of corresponding components and parts being monitored,
comparing sensor data with reference sensor data and identifying sensor data showing discrepancies from the reference sensor data,
determining if the sensor data show discrepancies above a pre-set level,
transmitting, from the computing device to the system controller of the automated storage and retrieval system, data representing sensor data above the pre-set level,
processing and analysing, in the system controller, the data representing the sensor data above the pre-set level, and identifying the corresponding components and parts, and
initiating, based on the analysis in the system controller, maintenance of the identified components or parts.

The processing and analysis of the sensor data can be performed according to an algorithm where the sensor data are examined according to a set of rules. This may for instance include checking if the sensor data have measured values outside a pre-set measurement interval. The analysis may further reflect active operating time for different components and parts, which may indicate if replacements should be performed.

Recording sounds from automated vehicles during operation can expose possible problems. For instance, an appearance of a new sounds, e.g. a clacking sound, may indicate a problem.

According to one embodiment, the system controller controls an automated vehicle according to type of maintenance needed. If not very urgent, this may include reducing the operational speed of an automated vehicle until a period with less activity of the automated storage and retrieval system, e.g. at night. It may also include only allowing the automated vehicle to pick up lighter weight containers or sends it off to charge at more frequent intervals.

The system controller can then initiate the necessary steps for maintenance of the automated vehicle.

According to one embodiment, the start time of an operation of an automated vehicle and the stop time of an operation when the operation is completed with discrepancies below the pre-set level are registered and stored in the storage device.

According to one embodiment, the start time of an operation of an automated vehicle, and the time it is determined that the data are above the pre-set level are registered and stored in the storage device.

According to one embodiment, the identified sensor data showing discrepancies from the reference sensor data are ranked according to degree of discrepancy, and where only sensor data having the highest degree of discrepancy are transmitted to the system controller for further analysis when the automated vehicle has low or no activity.

The activity level of an automated vehicle can be detected by the automated vehicle itself. If it is at a standby and waiting for operational instructions, there will be no activity and motors enabling driving or lifting operations will not run. Low activity can for instance be in a period between two operations, e.g. the automated vehicle has just finished an operation and is ready to receive instructions for the next operation.

Further, low or no activity can be determined based on signal transmission activity between an automated vehicle and the system controller. Minimal signal transmission activity may indicate low or no activity.

During periods with low or no activities, used bandwidth of a wireless network is expected to be minimal, thereby occupying minimal bandwidth of a wireless network.

According to one embodiment, all sensor data showing discrepancies are transmitted from the computing device to the system controller of the automated storage and retrieval system when an automated vehicle has low or no activity.

According to one embodiment, all stored sensor data registered from start to stop of an operation are transmitted from the computing device to the system controller of the automated storage and retrieval system when an automated vehicle has low or no activity.

The invention further comprises a computer program product that when executed in a processor by a computing device is arranged to monitor autonomous operations of an automated vehicle comprising the computing device which is connected to a storage device and to sensors. The following steps are performed:
continuously receiving, storing, processing and analysing sensor data from the sensors, including identifications of corresponding components and parts being monitored,
comparing sensor data with reference sensor data and identifying sensor data showing discrepancies from the reference sensor data,
determining if the sensor data show discrepancies above a pre-set level,
initiating transmission, from the computing device to the system controller of the automated storage and retrieval system, of data representing sensor data above the pre-set level.

The invention further comprises a software program product, that when executed in a system controller arranged to control and monitor operations of an automated storage and retrieval system performs the steps of:
receiving data comprising sensor data from automated vehicles operating the automated storage and retrieval system,
processing and analysing the sensor data, identifying, and initiating maintenance for components and parts according to type of maintenance needed.

In addition to the mentioned data transfer problem, when transferring large amounts of data over a wireless network with restricted bandwidth, the computing device in each an automated vehicle, which is arranged to continuously receive, store, process and analyse sensor data from the sensors, may also reduce response time if faults needing immediate attention are detected. By only transmitting data reflecting faults needing immediate attention to a system controller, controlling a plurality of automated vehicles, less data must be processed centrally by the system controller.

### BRIEF DESCRIPTION OF THE DRAWINGS

The following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 illustrates a computing device connected to a storage device and sensors, arranged to monitor components and parts of an automated vehicle and to communicate with a system controller.

FIG. 3 is a flowchart of a method for automated condition-based maintenance showing the basic concept and operation of a computing device connected to sensors arranged to monitor components and parts of an automated vehicle.

FIG. 4 is a flowchart showing an embodiment of the method for automated condition-based maintenance, where data showing less serious discrepancies are transmitted from an automated vehicle having low activity.

FIG. 5 is a flowchart of another embodiment for automated condition-based maintenance of an automated vehicle, comprising ranking of data.

### DETAILED DESCRIPTION OF THE INVENTION

In the following description, the invention will be explained in more detail by way of example only and with reference to the appended drawings. It should be understood, however, that the drawings are not intended to limit the invention to the subject-matter depicted in the drawings.

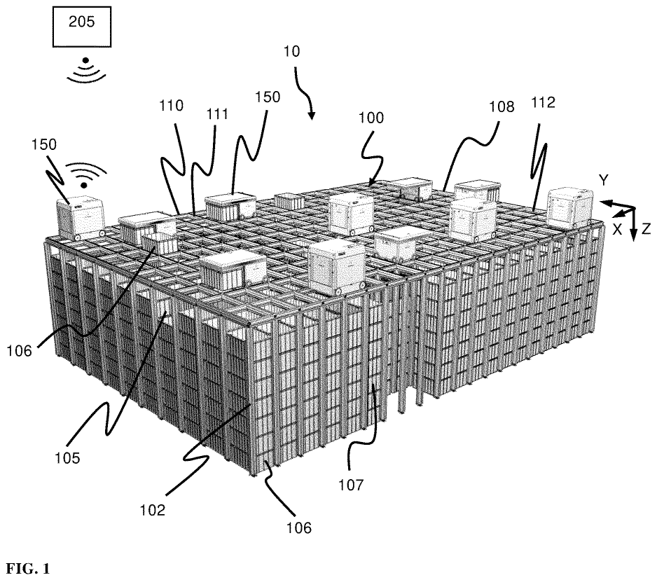

A typical prior art automated storage and retrieval system 10 with a framework structure 100 was described in the background section above with reference to FIG. 1.

The framework structure 100 can be of any size, and it is understood that it can be considerably wider and/or longer and/or deeper than the one disclosed in FIG. 1. For example, the framework structure 100 may have a horizontal extent of more than 700×700 storage columns 105 and a storage depth for storing more than eight stacked storage containers 106, and where storage containers 106 are handled by hundreds of automated vehicles 150 running on the rail system 108. The rail system may be installed on top of the framework structure 100 and/or in the middle of the framework structure 100, and/or below the framework structure 100. The automated vehicles will then be able to handle storage containers 106 in storage columns 105 from different positions in the Z-directions where the rail system is installed.

Also, the framework structure 100 can be considerably deeper than the one disclosed in FIG. 1. For example, the framework structure 100 may be more than eight grid cells 122 deep, i.e. in the Z-direction indicated in FIG. 1.

For monitoring and controlling the automated storage and retrieval system 10, a system controller 205 with a database keeps track of the location of each storage container 106 as well as which storage container 106 to handle at any time. The system controller 205 further controls each automated vehicle 150 by transmitting control instructions and receiving confirmation signals.

For larger systems comprising hundreds or even thousands of automated vehicles 150, real-time communication between automated vehicles 150 and the system controller 205 can be quite extensive and subjected to interference. The quality of wireless communication is restricted by available bandwidth.

Adding prediction and handling of condition-based need for maintenance of an automated storage and retrieval system 10 will load communication between storage containers 106 and the system controller 205 even more, resulting in possible malfunctioning.

The present solution addresses this by monitoring components and parts of an automated vehicle 150 and only transmitting data of components and parts needing immediate attention to the system controller 205 or transmitting data in a period where an automated vehicle 150 has low or no activity.

The automated vehicle 150 that is monitored can be of any type operating on an automated storage and retrieval system 10, such as an automated vehicle retrieving a storage container 106 from a storage columns 105 and transporting it to a destination location, or picking up a storage container and placing it in a storage column 105.

The automated vehicle 150 can also be drone transporting storage containers 106 between storage columns 105, or a harvester picking items picking and placing items in storage container 106. It can further be a service vehicle configured to perform service on other types of automated vehicles 150.

The different types of automated vehicles 150 can run on rail systems 108 installed in different levels of an automated storage and retrieval system, e.g. on top of the framework structure 100, in the middle of the framework structure 100, or below the framework structure 100.

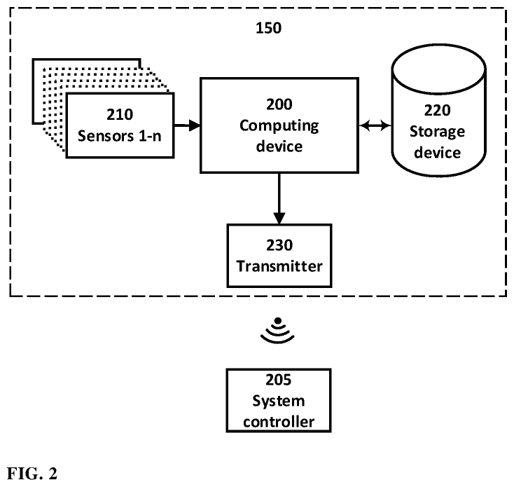

FIG. 2 illustrates a computing device 200 connected to storage device 220 and sensors 210 arranged to monitor components and parts of an automated vehicle 150 and to communicate with a system controller 205. The computing device can be a separate computing device running monitoring software. The monitoring software can also be executed on a computing device controlling the operations of the automated vehicle 150. An operation assigned to an automated vehicle 150 may for instance be to drive to a storage column 105 at a specified location to store or retrieve a storage container 150.

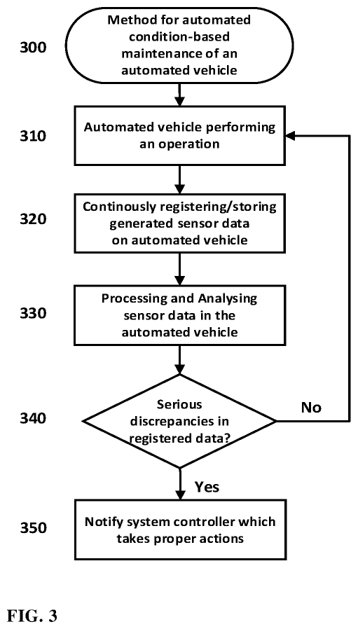

FIG. 3 is a flowchart of a basic concept of a method 300 for automated condition-based maintenance of an automated vehicle 150. The flowchart shows the basic concept and operation of a computing device 200 connected to sensors 210 arranged to monitor components and parts of an automated vehicle 150.

When an automated vehicle 150 performs an operation 310, the components and parts enabling the operation are being monitored by the sensors 210 generating sensor data. The sensor data are continuously registered and stored 320 in the storage device 220 connected to the computing device 200 in the automated vehicle 150.

The generated sensor data are continuously processed and analysed 330. The processing and analysis of the generated sensor data can be performed according to an algorithm where the sensor data are examined according to a set of rules. This may for instance include checking if the sensor data have measurement values outside a pre-set measurement interval.

During processing of the sensor data 330, it is checked 340 if there are data reflecting serious discrepancies from expected sensor data. A serious discrepancy may for instance be that a temperature of a component increases rapidly, or that a new and unexpected sound suddenly occurs.

If a serious discrepancy occurs, the system controller 205 is notified immediately 350 by transmitting the relevant sensor data to the system controller 205, which then will further assess the received sensor data and control the automated vehicle 150 that transmitted the sensor data with discrepancies. How the automated vehicle 150 then is controlled by the system controller 205 will be based on the type of fault.

It might be important to continuously and centrally monitor a selected number of sensors that are measuring especially vulnerable components or parts in one or more automated vehicles 150. Such sensor data may be continuously transmitted to the system controller 205 independently of whether a serious deficiency is detected in the sensor data or not.

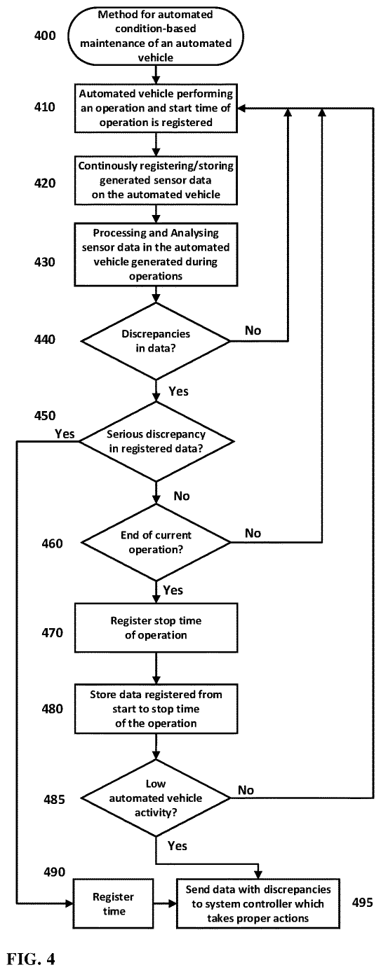

FIG. 4 is a flowchart showing an embodiment of the condition-based method 400 where data showing less serious discrepancies are transmitted from an automated vehicle 150 when it has low activity. The method is based on the method described above but comprises additional steps.

The start time of an operation of an automated vehicle 150 is registered 410, and sensor data are continuously registered and stored 420 in the storage device 220 connected to the computing device 200 in the automated vehicle 150. During processing of the sensor data 430, it is checked 440 if there are data reflecting discrepancies from expected sensor data. If this is the case, it is further checked 450 if the discrepancies reflect a serious problem needing immediate follow-up.

If the discrepancies do reflect a serious problem, the system controller 205 is immediately notified 495 by transmitting the time the problem occurred 490 and the relevant sensor data to the system controller 205 which will further assess the received sensor data and control the automated vehicle 150.

On the other hand, if the discrepancies do not reflect a serious problem, it is checked 460 if the automated vehicle 150 has finished its current operation 460. If not, the current operation of the n automated vehicle 150 is continued in step 410 after registering the time.

When less serious discrepancies are found in sensor data and an operation has finished, the stop time of the operation is registered 470, and sensor data registered from the start time of the operation until the stop time of the operation are registered in the storage device 220 connected to the computing device 200 in the automated vehicle 150.

After finishing an operation, it is checked 485 if the automated vehicle 150 has low or no activity. If for instance another operation is started immediately after previous operation has finished, the automated vehicle 150 will be kept active and the operation continuous in step 410 until a possible serious problem serious problem needing immediate follow-up is detected 450.

If it is determined that the automated vehicle 150 has low or no activity, the sensor data showing discrepancies are transmitted from the transmitter 230 of the automated vehicle 150 to the system controller 205 of the automated storage and retrieval system 10. The system controller will then further assess the received sensor data and control the automated vehicle 150 which transmitted the sensor data having discrepancies.

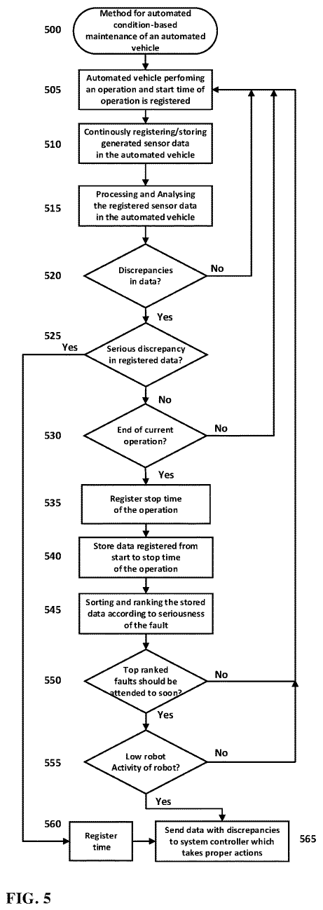

FIG. 5 is a flowchart illustrating yet another embodiment for automated condition-based maintenance of an automated vehicle 150 where ranking of data is performed 500. The method comprises ranking of sensor data having discrepancies from reference senor data.

The start time of an operation of an automated vehicle 150 is registered 505, and sensor data are continuously registered and stored 510 in the storage device 220 connected to the computing device 200 in the automated vehicle 150. During processing of the sensor data 515, it is checked 520 if there are data reflecting discrepancies from expected sensor data. If this is the case, it is further checked 525 if the discrepancies reflect a serious problem needing immediate follow-up.

If the discrepancies reflect a serious problem, the system controller 205 is immediately notified 565 by transmitting the time the problem occurred 560 and the relevant sensor data to the system controller 205, which will further assess the received sensor data and control the automated vehicle 150.

If, on the other hand, the discrepancies do not reflect a serious problem, it is checked if the automated vehicle 150 has finished its current operation 530. If not, it will continue its current operation until the operation has been performed, i.e. returning to step 505.

When less serious discrepancies in data are found and an operation has finished, the stop time of the operation is registered 535, and sensor data registered from the start time of the operation until the stop time of the operation are registered 540 in the storage device 220 connected to the computing device 200 in the automated vehicle 150. The sensor data reflecting discrepancies during an operation are then sorted and ranked 545 according to seriousness of reflected faults.

It is then checked if top ranked faults should be attended to soon. If so, it is checked if the automated vehicle 150 has low or no activity 555. If not, the automated vehicle 150 will continue its operation, i.e. returning to step 505 until a possible serious problem serious problem needing immediate follow-up is detected 525, or the automated vehicle 150 has low or no activity.

If it is determined that the automated vehicle 150 has low or no activity, the sensor data showing discrepancies that should be attended to soon are transmitted 565 from the transmitter 230 of the n automated vehicle 150 to the system controller 205 of the automated storage and retrieval system 10. The system controller 205 will then further assess the received sensor data and control the automated vehicle 150 which transmitted the sensor data with discrepancies.

As mentioned, different kinds of faults may occur during operations of an automated vehicle 150. Some are only minor faults that do not need immediate attention. By registering and storing sensor data representing minor faults locally in an automated vehicle 150, less signal transmission to and from automated vehicles 150 are needed, thereby reducing bandwidth requirements when operating an automated storage and retrieval system 10.

1-13. (canceled)

14. A system for automated prediction and handling of condition-based need for maintenance of an automated storage and retrieval system comprising a framework structure having upright members defining storage columns for storing rows of stacked storage containers, the framework structure comprises a rail system enabling a plurality of automated vehicles to handle storage containers to and from the automated storage and retrieval system, wherein the automated storage and retrieval system is controlled by a system controller, each automated vehicle comprises a computing device connected to sensors arranged to monitor components and parts enabling autonomous operations, wherein:
the computing device is connected to a storage device, and arranged to continuously receive, store, process and analyse sensor data from the sensors, where the sensor data comprise identifications of corresponding monitored components and parts, and where sensor data showing discrepancies from reference sensor data are identified,
a transmitter connected to the computing device that is arranged to transmit, to the system controller, data showing discrepancies above a pre-set level from the reference sensor data, and where the system controller is adapted to process and analyse the data, and initiate maintenance of the identified components and/or parts.

15. The system according to claim 14, wherein the sensors monitoring components and parts of the automated vehicle comprise one or more of temperature sensor, sound sensor, humidity sensor, vibration sensor, and speed sensor.

16. A method for automated prediction and handling of condition-based need for maintenance of an automated storage and retrieval system comprising a framework structure having upright members defining storage columns for storing rows of stacked storage containers, the framework structure comprises a rail system enabling a plurality of automated vehicles to handle storage containers to and from the automated storage and retrieval system, wherein the automated storage and retrieval system is controlled by a system controller, each automated vehicle comprises a computing device connected to a storage device and sensors arranged to monitor components and parts enabling autonomous operations, wherein the method comprises the following steps:
continuously receiving, storing, processing and analysing sensor data from the sensors, including identifications of corresponding components and parts being monitored,
comparing sensor data with reference sensor data and identifying sensor data showing discrepancies from the reference sensor data,
determining if the sensor data show discrepancies above a pre-set level,
transmitting, from the computing device to the system controller of the automated storage and retrieval system, data representing sensor data above the pre-set level,
processing and analysing, in the system controller, the data representing the sensor data above the pre-set level, and identifying the corresponding components and parts, and
initiating, based on the analysing in the system controller, maintenance of the identified components or parts.

17. The method according to claim 16, registering and storing in the storage device, a start time of an operation of an automated vehicle, and a stop time of the operation when the operation is completed with discrepancies below the pre-set level.

18. The method according to claim 16, registering and storing in the storage device, a start time of an operation of an automated vehicle, and a time it is determined that the data are above the pre-set level.

19. The method according to claim 16, wherein identified sensor data showing discrepancies from the reference sensor data are ranked according to degree of discrepancy, and where only sensor data having a highest degree of discrepancy are transmitted to the system controller for further analysis when the automated vehicle has low or no activity.

20. The method according to claim 16, wherein all the sensor data showing discrepancies are transmitted from the computing device to the system controller of the automated storage and retrieval system when an automated vehicle has low or no activity.

21. The method according to claim 16, wherein all stored sensor data registered from start to stop of an operation are transmitted from the computing device to the system controller of the automated storage and retrieval system when an automated vehicle has low or no activity.

22. The method according to claim 16, wherein the reference sensor data are previously stored data.

23. The method according to claim 16, where the reference sensor data are data generated from the sensors in each automated vehicle during normal operations.

24. The method according to claim 16, wherein the system controller controls an automated vehicle according to type of maintenance needed.

25. A computer program product that when executed in a processor by a computing device is arranged to monitor autonomous operations of an automated vehicle comprising the computing device which is connected to a storage device and to sensors, performs the steps of:
continuously receiving, storing, processing and analysing sensor data from the sensors, including identifications of corresponding components and parts being monitored,
comparing sensor data with reference sensor data and identifying sensor data showing discrepancies from the reference sensor data,
determining if the sensor data show discrepancies above a pre-set level,
initiating transmission, from the computing device to a system controller of an automated storage and retrieval system, of data representing sensor data above the pre-set level.

26. A software program product, that when executed in a system controller arranged to control and monitor operations of an automated storage and retrieval system performs the steps of:
receiving data comprising sensor data from automated vehicles operating the automated storage and retrieval system,
processing and analysing the sensor data, identifying, and initiating maintenance for components and parts according to type of maintenance needed.
